(19) United States
(12) Patent Application Publication
(10) Pub. No.: US 2007/0083504 A1
(43) Pub. Date: Apr. 12, 2007

(54) Selecting information technology components for target market offerings

(76) Inventors: Michael W. Britt, Rochester, MN (US); Thomas D. Christopherson, Rochester, MN (US); Thomas P. Pitzen, Rochester, MN (US); Christopher H. Wicher, Raleigh, NC (US); Patrick M. Wildt, Rochester, MN (US)

Correspondence Address: MARCIA L. DOUBET LAW FIRM, PO BOX 422859, KISSIMMEE, FL, 34742, US

(21) Appl. No.: 11/244,789

(22) Filed: Oct. 6, 2005

(51) Int. Cl. G06F 17/30

(52) U.S. Cl. 707/5

(57) ABSTRACT

Techniques for selecting IT components (including components still under development) in view of ones thereof that will be most beneficial for incorporating into a component library and/or into products and solutions for a target market or markets. A set of criteria are evaluated with regard to each component. Each of the criteria may have one or more attributes, and may be different in priority from one another. In preferred embodiments, a component consumability score is created as a result of the comparison. The criteria/attributes used in creating this score are preferably weighted in view of their importance to the target market, and the consumability scores for components are preferably provided to component teams to influence component harvesting, planning, and/or development efforts.

### CROSS-REFERENCE TO RELATED APPLICATIONS

The present application is related to the following commonly-assigned and co-pending U.S. patent applications, which were filed concurrently herewith: Ser. No. 10/______, which is titled “Market-Driven Design of Information Technology Components”; Ser. No. 10/______, which is titled “Assessing Information Technology Components”; and Ser. No. 10/______, which is titled “Role-Based Assessment of Information Technology Packages”. The first of these related applications is referred to herein as “the component design application”. The present application is also related to the following commonly-assigned and co-pending U.S. patent applications, all of which were filed on May 16, 2003 and which are referred to herein as “the related applications”: Ser. No. 10/612,540, entitled “Assessing Information Technology Products”; Ser. No. 10/439,573, entitled “Designing Information Technology Products”; Ser. No. 10/439,570, entitled “Information Technology Portfolio Management”; and Ser. No. 10/439,569, entitled “Identifying Platform Enablement Issues for Information Technology Products”.

### BACKGROUND OF THE INVENTION

The present invention relates to information technology (“IT”), and deals more particularly with selecting IT components (including components still under development) in view of ones thereof that will be most beneficial for incorporating into a component library and/or into products and solutions for a target market or markets.

As information technology products become more complex, developers thereof are increasingly interested in use of software component engineering (also referred to as “IT component engineering”). Software component engineering focuses, generally, on building software parts as modular units, referred to hereinafter as “components”, that can be readily consumed and exploited by a higher-level software package or offering (such as a software product), where each of the components is typically designed to provide a specific functional capability or service.

Software components (referred to equivalently herein as “IT components” or simply “components”) are preferably reusable among multiple software products. For example, a component might be developed to provide message logging, and products that wish to include message logging capability may then “consume”, or incorporate, the message logging component. This type of component reuse has a number of advantages. As one example, development costs are typically reduced when components can be reused. As another example, end user satisfaction may be increased when the user experiences a common “look and feel” for a particular functional capability, such as the message logging function, among multiple products that reuse the same component.

When a sufficient number of product functions can be provided by component reuse, a development team can quickly assemble products and solutions that produce a specific technical or business capability or result.

One approach to component reuse is to evaluate an existing software product to determine what functionality, or categories thereof, the existing product provides. This approach, which is commonly referred to as “functional decomposition”, seeks to identify functional capabilities that can be “harvested” as one or more components that can then be made available for incorporating into other products.

However, functional decomposition has drawbacks, and mere existence of functional capability in an existing product is not an indicator that the capability will adapt well in other products or solutions.

### BRIEF SUMMARY OF THE INVENTION

The present invention provides techniques for selecting IT components. In one preferred embodiment, this comprises: determining a plurality of criteria that are important to a target market, and at least one attribute to be used for measuring each of the criteria; specifying objective measurements for each of the attributes; conducting an evaluation of an IT component; and generating a consumability score, for the IT component. Conducting the evaluation preferably further comprises: inspecting a representation of the IT component, with reference to selected ones of the attributes; and assigning attribute scores for the selected attributes, according to how the IT component compares to the specified objective measurements. Generating the consumability score preferably further comprises: comparing the assigned attribute scores to product or baseline scores for each attribute; multiplying a result of each comparison by a weight associated with the attribute to yield a differential attribute score; and summing the differential attribute scores.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will now be described with reference to the following drawings, in which like reference numbers denote the same element throughout.

### BRIEF DESCRIPTION OF THE SEVERAL VIEWS OF THE DRAWINGS

FIG. 1 provides an overview of a component assessment and consumability scoring approach, according to preferred embodiments of the present invention, and FIG. 2 illustrates how a baseline or product assessment score may be used when computing a component's consumability score;

FIG. 3 provides a chart summarizing a number of sample criteria and attributes for assessing software with regard to particular market requirements;

FIG. 4 depicts example rankings showing the relative importance of requirements for IT purchasers in a sample target market segment;

FIG. 5 shows an example of textual descriptions that may be defined to assist component assessors in assigning values to attributes in a consistent, objective manner;

FIG. 6 provides a flowchart that illustrates, at a high level, actions that are preferably carried out when establishing an assessment process according to the present invention;

FIG. 7 describes performing a component assessment in an iterative manner;

FIG. 8 provides a flowchart that depicts details of how a component assessment may be carried out;

FIG. 9 (comprising FIGS. 9A-9C) contains a sample questionnaire, of the type that may be used to solicit information from a development team whose IT component will be assessed;

FIG. 10 depicts an example of how two different component assessment scores may be used for assigning special designations to assessed components;

FIG. 11 illustrates a sample component assessment report showing per-attributes scores as well as a consumability score created using those scores; and

FIG. 12 shows a sample component assessment summary report.

### DETAILED DESCRIPTION OF THE INVENTION

The present invention provides techniques for selecting IT components for incorporating into (i.e., consumption by) products and solutions intended for a target market or markets. One or more components assessments are performed, and “consumability” scores are created for the assessed components. This consumability score may be used to rank multiple components, and provides an indicator of how well the associated component will enable (or hinder) consuming products in achieving specific requirements of the target market, as will be described in more detail herein.

Code harvested from existing products as a reusable component can be assessed to ensure that the component is suited for reusability. By assessing a harvested component in view of its intended use, components can be provided that improve market acceptance for a particular consuming application and/or target market. Furthermore, newly-developed components—or plans or designs therefor—can be assessed using techniques disclosed herein.

As discussed earlier, the functional decomposition approach has drawbacks when creating software components by harvesting functionality from existing products. As one example, a drawback of the functional decomposition approach is that no consideration is generally given during the decomposition process as to how the harvested component(s) will ultimately be used, or to the results achieved from such use. This may result in the creation of components that do not achieve their potential for reuse and/or that fail to satisfy requirements of their target market or target audience of users. Suppose a message logging capability is identified as a reusable component during functional decomposition, for example. If the code providing that message logging capability performs inefficiently or has poor usability, then these disadvantages will be propagated to other products that reuse the message logging component. As another example, a functional capability for providing an administrative interface within a product might be identified as a potential component for harvesting. However, an assessment of this functional capability, conducted using techniques disclosed herein, might indicate that the code providing this administrative interface capability has a number of other inhibitors that would be detrimental when the code is consumed by other products.

In addition, because it seeks to break down already-existing code into components, the functional decomposition approach does not seek to provide components that are designed specifically to satisfy particular market requirements or market requirements which may be of most importance in the target market.

The related application entitled “Assessing Information Technology Products” (Ser. No. 10/612,540) defines techniques for assessing a product as a whole. Components included in the product are assessed only insofar as functionality of the component may be incidentally exposed by the product. If a product includes one or more components that have undesirable characteristics, for example, these characteristics may be attributed to the product as a whole, but it is not evident that the source of the undesirable characteristics is one or more particular components. Accordingly, remedial steps (such as replacing a component or altering a component's functionality to improve it characteristics) are not easily identifiable.

A number of other challenges exist when using current approaches to component use, whereby a consuming product is expected to incorporate components into an offering (where a software offering is also referred to herein as a software product, by way of illustration). One challenge is in selecting a component, from among a plurality of components provided (for example) by a component library or toolkit, that best fits the needs of a target usage. If more than one component is available that provides a particular functional capability, current practice typically selects from among those available components in an ad hoc manner. Accordingly, components may be selected that provide less than optimal results. An additional challenge exists for determining what component from a plurality of available components would provide the most noticeable improvement if incorporated into a consuming product. For example, components with similar functional capabilities might have different implementations or inherent characteristics that either help or hinder the overall experience of the final software product. No current approaches are known to the present inventors that enable evaluation of such information when selecting from among the available components. With no mechanism for evaluating the relative improvement potential of particular components, ad hoc selection may again be used, with its less-than-optimal results.

As a further challenge, development teams have limited bandwidth for incorporating components into an offering, and a prioritization mechanism is therefore desirable to assist in selecting components that may be incorporated. Using a consumability score as disclosed herein, higher-ranking components may be prioritized for inclusion into a consuming product.

A development team that wishes to construct a component library will also benefit from techniques disclosed herein, which enable components to be compared and ranked in meaningful ways, as will be discussed in more detail herein.

The related application titled “Assessing Information Technology Components” (Ser. No. 10/______) discloses techniques for assessing components in view of a set of attributes. A component assessment score is created, as disclosed therein. The present invention extends the disclosed techniques beyond component-specific scores, such that a development team can determine how a particular component might benefit the assessment score of a specific product looking to incorporate that component. Development teams may also use techniques disclosed herein to determine how an assessed component might help improve particular attribute scores for a consuming product.

In preferred embodiments, the present invention provides techniques for selecting IT components by comparing a component (including a component still under development) to a set of criteria that are designed to measure the component's success at addressing requirements of a target market, and the potential improvement to a consuming product with regard to each of these attributes, where each of these criteria has one or more attributes. The measurement criteria may be different in priority from one another, and may therefore be weighted such that varying importance of particular requirements to the target market can be reflected. In preferred embodiments, a per-attribute assessment score is created and compared to a product score to determine a per-attribute change in the product's assessment score for that attribute, and an overall component consumability score is then computed using the per-attribute information. When necessary, a set of recommendations for changing a component may also be created.

The term “differential scoring” is used herein to refer to the per-attribute change in assessment score that is attributed to incorporating an assessed component into a product. The impact of this differential scoring yields a consumability score for the assessed component.

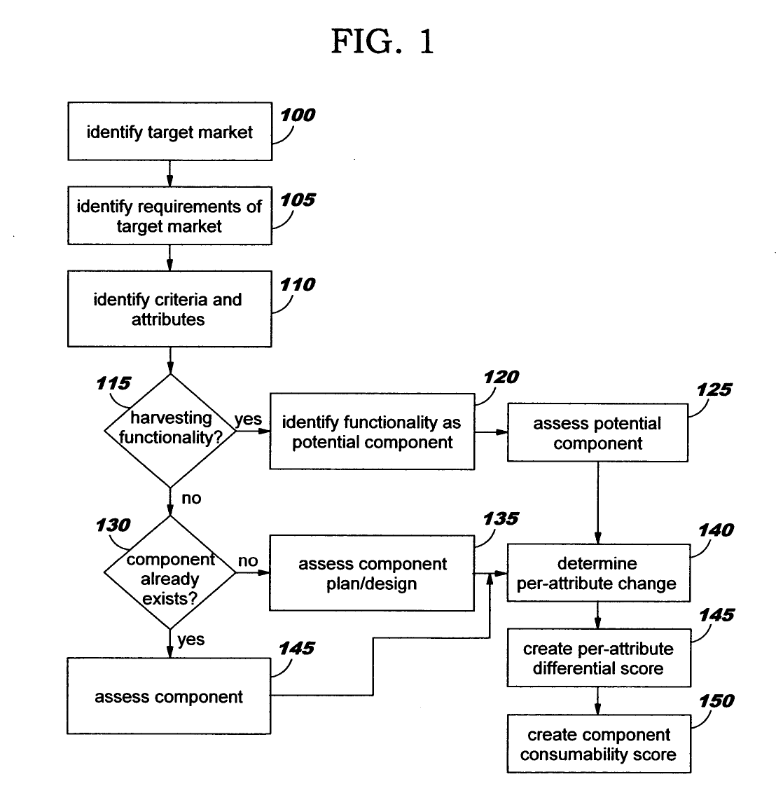

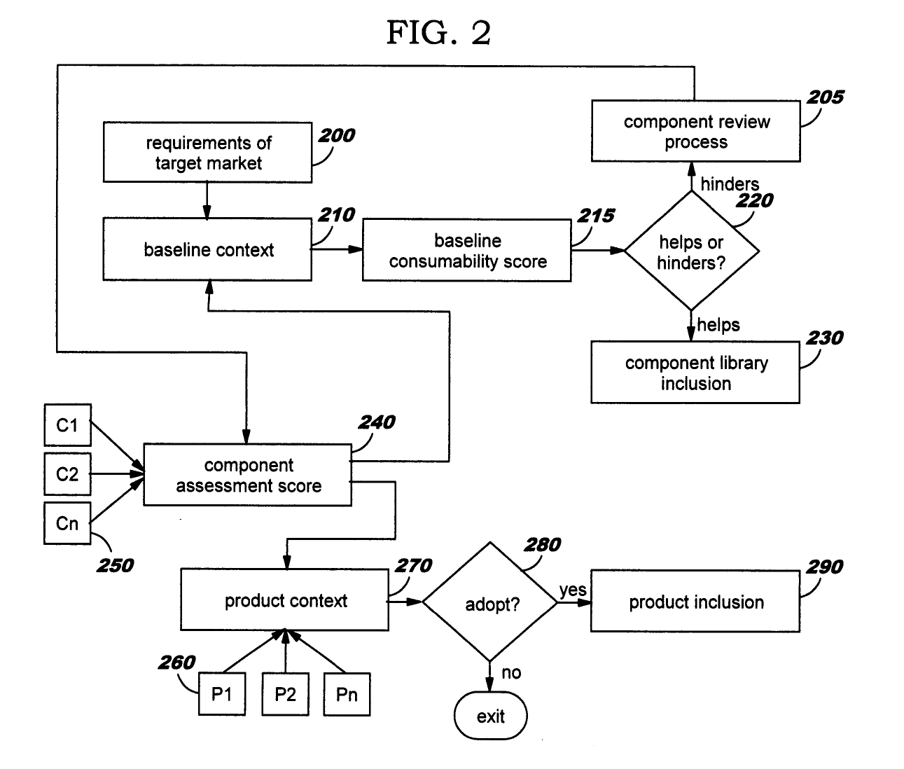

Referring now to FIG. 1, an overview is provided of a component assessment and consumability scoring approach according to preferred embodiments of the present invention. As shown therein at Block 100, a target market or market segment is identified. (The terms “target market” and “market segment” are used interchangeably herein.)

Requirements of the identified target market are also identified (Block 105). As discussed in the related applications, a number of factors may influence whether an IT product is successful with its target market, and these factors may vary among different segments of the market. Accordingly, the requirements that are important to the target market are used in assessing components to be provided in products and solutions (referred to herein more generally as “products”) to be marketed therein.

Criteria of importance to the target market, and attributes for measurement thereof, are identified (Block 110) for use in the assessment process. Multiple attributes may be defined for any particular requirement, as deemed appropriate. High-potential attributes may also be identified. Objective means for measuring each criterion are preferably determined as well. Preferably, weights to be used with each criterion/attribute are also be determined, where each weight indicates how important that criterion/attribute is to acceptance of a product in the target market.

As one example, if an identified requirement is “reasonable footprint”, then a measurement attribute may be defined such as “requires less than . . . [some amount of storage]”; or, if an identified requirement is “easy to learn and use”, then a measurement attribute may be defined such as “novice user can use functionality without reference to documentation”. Degrees of support for particular attributes may also be measured. For example, a measurement attribute of the “easy to learn and use” requirement might be specified as “novice user can successfully use X of 12 key functions on first attempt”, where the value of“X” may be expressed as “1-3”, “4-6”, “7-9”, and so forth.

Market segments may be structured in a number of ways. For example, a target market for an IT product may be segmented according to industry. As another example, a market may be segmented based upon company size, which may be measured in terms of the number of employees of the company. The manner in which a market is segmented does not form part of the present invention, and techniques disclosed herein are not limited to a particular type of market segmentation. Furthermore, the attributes of importance to a particular market segment may vary widely, and embodiments of the present invention are not limited to use with a particular set of attributes. Attributes discussed herein should therefore be construed as illustrating, but not limiting, use of techniques of the present invention.

Block 115 asks whether the component assessment is to be conducted with regard to functionality to be harvested from an existing product. If so, then at Block 120, functionality from the existing product is identified as a potential component (or multiple potential components), and the assessment is then carried out (Block 125) with regard to the identified potential component(s).

If the test at Block 115 has a negative result, then at Block 130, a test is made to determine whether the component assessment is to be conducted with regard to functionality of an existing component. If so, then the assessment is carried out (Block 145) with regard to the existing component.

If the test at Block 130 has a negative result, then the assessment is carried out (Block 135) with regard to plans and/or design specifications for a component that does not yet exist.

In an alternative approach, the assessment at any of Blocks 125, 135, and 145 may comprise using component-specific adaptations or refinements of the identified market requirements, criteria, attributes, and/or weights that have been identified (refer to the discussion of Blocks 100-110), in order to provide assessment results that are better tailored to characteristics of individual components. This has not been illustrated in FIG. 1. Accordingly, in this alternative approach, the information gathered at Blocks 100-110 may be adapted prior to the component-specific assessment, such that the assessment then uses the adapted/refined information.

Block 140 determines the per-attribute change in product assessment score that may result if the assessed component is consumed by a particular product. Preferably, this comprises comparing the component's score on each assessed attribute to a baseline or product score for that attribute. In preferred embodiments, this comprises subtracting the baseline or product score from the component score. This per-attribute comparison may yield a positive or a negative result, indicating that the attribute will be helpful to, or a hindrance to, respectively, products that choose to incorporate this component. The comparison results for each attribute are preferably multiplied by a scaling factor, which in preferred embodiments is the weight associated with each of the criteria/attributes, thereby creating a per-attribute differential score (Block 145). A component consumability score is then created (Block 150) from these differential scores. Preferably, the differential scores for all assessed attributes of the component are summed to create the consumability score.

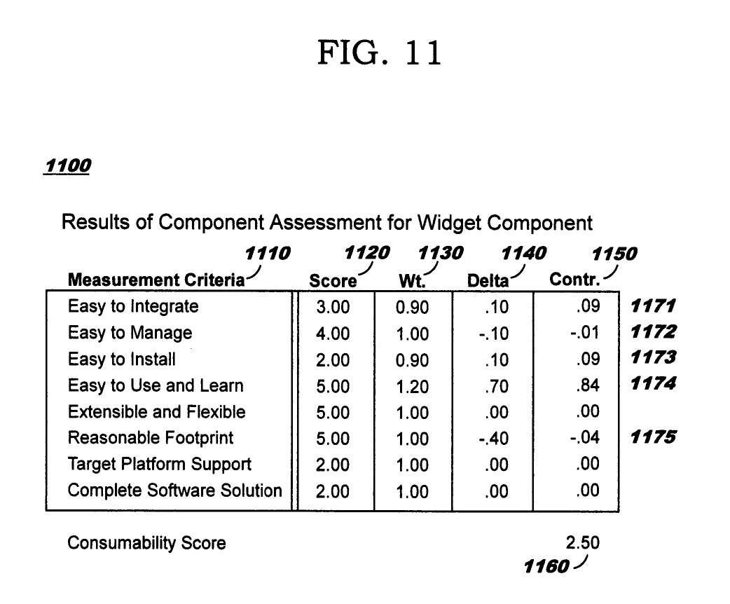

Once the consumability score for a component has been generated, it may be used in various ways (which have not been illustrated in FIG. 1). In particular, consumability scores may be used for selecting among a set of potential components to be consumed by a product, whereby a component with a highest consumability score is generally preferable over others with similar functional capability. The consumability score may also be used to gauge the degree of improvement to a product's market acceptance—and in particular, the amount of improvement that may be realized in the product's assessment score—that may be achieved if the product chooses to incorporate a component. Consumability scores may be used to determine whether a particular component is suited for inclusion in a component library or toolkit. And, consumability scores for a plurality of components providing different functional components may be used to evaluate how best to allocate limited product resources for component consumption (e.g., by ranking multiple components according to their potential improvement to the product's assessment score.) Refer also to the discussion of FIGS. 2 and 11, below, for more information.

It may be desirable to modify or redesign functional capabilities in view of the per-attribute differential scores. For example, if a component scores poorly on an attribute that has a relatively high weight, then it may be desirable to revise this aspect of the component to address the deficiencies. The assessment may then be repeated, followed by iteration of Blocks 140-150, although this has not been illustrated in FIG. 1.

As will be obvious, assessment of more than one component can be performed at Blocks 125, 135, and 145, and the subsequent processing depicted in FIG. 1 then applies to these multiple components.

Assessing components to be consumed by a product or solution, using the approach shown in FIG. 1 and described herein, improves the likelihood that the consuming product or solution will be viewed as useful to a particular target market. When harvesting functionality from an existing product (or, more generally, from existing technology), assessing that functionality using techniques described herein provides a “guided” functional decomposition, ensuring that a component being harvested will be advantageous with reference to its intended use. When assessing a component not yet developed, the assessment process described herein can be used to ensure that features are included that will support requirements which have been identified for the target market. Furthermore, assessing a component individually (rather than as part of a product) enables identifying component characteristics that may be detrimental with regard to, inter alia, a particular target market, which in turn allows such characteristics to be addressed and resolved so that the component is not detrimental to consuming products.

Techniques of the present invention are described herein with reference to particular criteria and attributes developed to assess software with reference to requirements that have been identified for a hypothetical target market, as well as with reference to component assessment scores and consumability scores that are expressed as numeric values. However, it should be noted that these descriptions are by way of illustrating use of the novel techniques of the present invention, and should not be construed as limiting the present invention to these examples. In particular, alternative target markets, alternative criteria and attributes, and alternative techniques for computing and expressing component assessment scores and consumability scores may be used without deviating from the scope of the present invention.

FIG. 2 illustrates how a baseline or product assessment score may be used when computing a component's consumability score, and expands on the discussion provided with reference to FIG. 1. As shown in FIG. 2, a plurality of components “C1”, “C2”, . . . “Cn” 250 are put through a component assessment process of the type described herein, yielding component scores 240 for each assessed attribute. Two different paths may then be taken through the flow of FIG. 2, as will now be described.

In a first approach, the component assessment score 240 for a particular component may be used with a baseline context 210, which has been created with regard to the requirements of the target market 200, yielding a consumability score 215 for the component in the baseline context. A test is made (see 220) as to whether this consumability score indicates that the component would help or hinder a consuming product's acceptance in this target market. If the component would hinder acceptance, then the component preferably undergoes a review process 205, whereby modifications may be made to the component. The component may then be reassessed to generate a new assessment score 240. On the other hand, if the component would help product acceptance, then this component may be included in a component library (see 230).

It may happen that a component's consumability score indicates areas where attributes of the component would hinder acceptance of consuming products, yet other attributes of that component would help acceptance. Weighting the attributes to produce differential scores, as discussed earlier, is directed toward achieving an overall determination of whether the component, as a whole, will be advantageous or detrimental. (However, in some implementations of techniques disclosed herein, it may be desirable to allow a component tradeoff analysis to be made in other ways.)

In a second approach, the component assessment score 240 for a particular component may be used with a product context 270, which has been created with regard to a particular product selected from among a plurality of products “P1”, “P2”, . . . “Pn” 260. Use of a product context enables evaluating a component with regard to incorporation in that particular context, and thus avoids potential problems where a component that might be advantageous in one context does not adapt well to another context. A component that is well suited for use in an enterprise computing environment, for example, might have too large a footprint for use in a small-to-medium-sized business environment (which in turn might lower the product assessment scores in that environment). Accordingly, a test is made (see 280) as to whether the component assessment indicates that this component should be adopted for use in this particular product context. If not, then FIG. 2 exits; otherwise, the component may be included in the product, as indicated at 290.

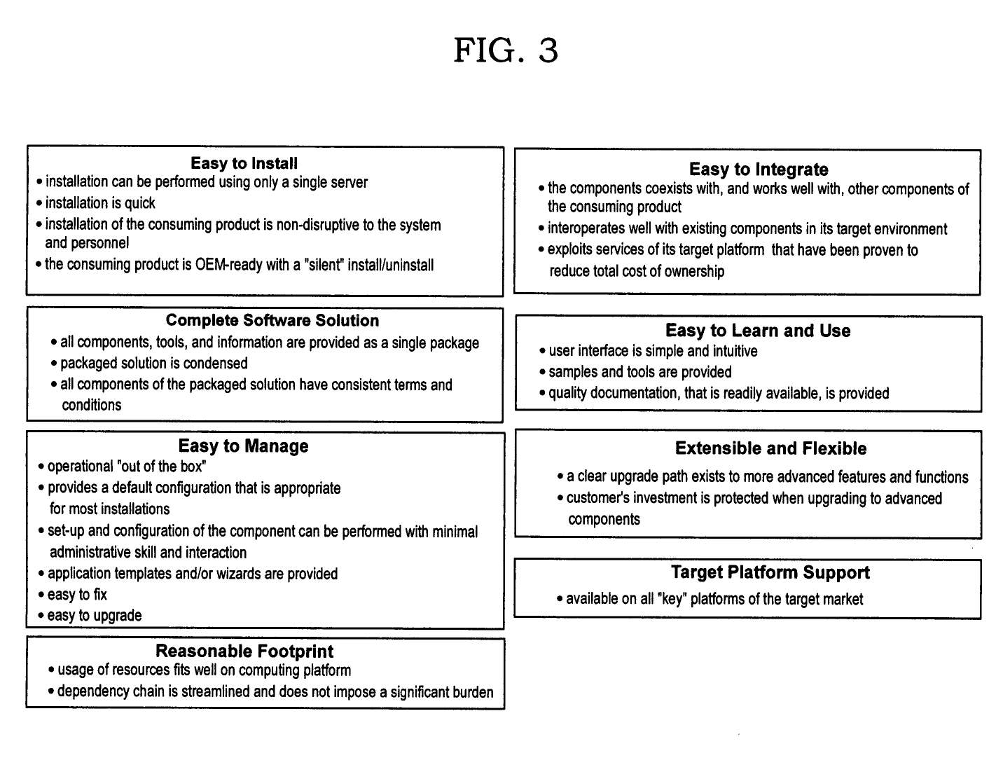

FIG. 3 provides a chart summarizing a number of criteria and attributes pertaining to market requirements, by way of example. These criteria and attributes will now be described in more detail.

Easy to Install. This criterion measures how easily the consuming product of the assessed component is installed in its intended market. Attributes used for this measurement may include: (i) whether the installation can be performed using only a single server; (ii) whether installation is quick (e.g., measurable in minutes, not hours); (iii) whether installation is non-disruptive to the system and personnel; and (iv) whether the package is OEM-ready with a “silent” install/uninstall (that is, whether the package includes functionality for installing and uninstalling itself without manual intervention).

Complete Software Solution. This criterion judges whether the consuming product of the assessed component provides a complete software solution for its users. Attributes may include: (i) whether all components, tools, and information needed for successfully implementing the consuming product are provided as a single package; (ii) whether the packaged solution is condensed—that is, providing only the required function; and (iii) whether all components of the packaged solution have consistent terms and conditions (sometimes referred to as “T's and C's”).

Easy to Integrate. This criterion is used to measure how easy it is to integrate the assessed component with other components. Attributes used in this comparison may include: (i) whether the component coexists with, and works well with, other components of the consuming product; (ii) whether the assessed component interoperates well with existing components in its target environment; and (iii) whether the component exploits services of its target platform that have been proven to reduce total cost of ownership.

Easy to Manage. This criterion measures how easy the assessed component is to manage or administer, if applicable. Attributes defined for this criterion may include: (i) whether the component is operational “out of the box” (e.g., as delivered to the developer, when provided as a reusable component of a development toolkit); (ii) whether the component, as delivered, provides a default configuration that is appropriate for most installations; (iii) whether the set-up and configuration of the component can be performed with minimal administrative skill and interaction; (iv) whether application templates and/or wizards are provided to simplify use of the component and its more complex tasks; (v) whether the component is easy to fix if defects are found; and (vi) whether the component is easy to upgrade.

Easy to Learn and Use. Another criterion to be measured is how easy it is to learn and use the assessed component. Attributes for this measurement may include: (i) whether the component's user interface is simple and intuitive; (ii) whether samples and tools are provided, in order to facilitate a quick and successful first-use experience; and (iii) whether quality documentation, that is readily available, is provided.

Extensible and Flexible. Another criterion used in the assessment is the component's extensibility and flexibility. Attributes used for this measurement may include: (i) whether a clear upgrade path exists to more advanced features and functions; and (ii) whether the customer's investment is protected when upgrading to advanced components or versions thereof

Reasonable Footprint. For many IT markets, the availability of computing resources such as storage space and memory usage is considered to be important, and thus a criterion that may be used in assessing components is whether the component has a reasonable footprint. Attributes may include: (i) whether the component's usage of resources such as random-access memory (“RAM”), central processing unit (“CPU”) capacity, and persistent storage (such as disk space) fits well on a computing platform used in the target environment; and (ii) whether the component's dependency chain is streamlined and does not impose a significant burden.

Target Market Platform Support. Finally, another criterion used when assessing components for the target market may be platform support. An attribute used for this purpose may be whether the component is available on all “key” platforms of the target market. Priority may be given to selected platforms.

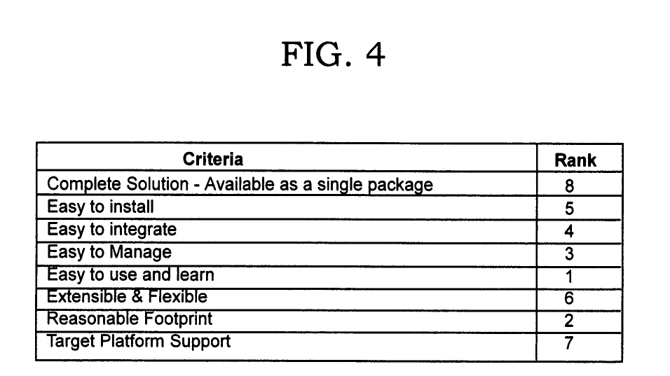

The particular criteria to be used for a component assessment, and attributes used for those criteria, are preferably determined by market research that analyzes what factors are significant to people making IT purchasing decisions. Preferred embodiments of the assessment process disclosed herein use these criteria and attributes as a framework for evaluating components. The market research preferably also includes an analysis of how important the various factors are in the purchasing decision. Therefore, preferred embodiments of the present invention allow weights to be assigned to attributes and/or criteria, enabling them to have a variable influence on a component's assessment and consumability scores. As stated earlier, these weights preferably reflect the importance of the corresponding attribute/criteria to the target market. Accordingly, FIG. 4 provides sample rankings with reference to the criteria in FIG. 3, showing the relative importance of these factors for IT purchasers in a hypothetical market segment.

It should be noted that the attributes and criteria that are important to IT purchasing decisions may change over time. In addition, the relative importance thereof may change. Therefore, embodiments of the present invention preferably provide flexibility in the assessment process and, in particular, in the attributes and criteria that are measured, in how the measurements are weighted, and/or in how a component's assessment and consumability scores are calculated using this information.

By using the framework of the present invention with its well-defined and objective measurement criteria and attributes, and its objective checkpoints, the assessment process can be used advantageously to guide and focus component harvesting/development efforts, as well as to gauge impacts of adding an already-developed component to a consuming product intended for a target market. (This will be described in more detail below. See, for example, the discussion of FIG. 11, which presents a sample component assessment report.)

Preferably, numeric values such as a scale of 1 to 5 are used when measuring each of the attributes during the assessment process. In this manner, relative degrees of support (or non-support) can be indicated. (Alternatively, another scale, such as 0 to 5, might be used.) In the examples used herein, a value of 5 indicates the best case, and 1 represents the worst case. In preferred embodiments, textual descriptions are provided for each numeric value of each attribute. These textual descriptions are designed to assist component assessors in performing an objective, rather than subjective, assessment. Preferably, the textual descriptions are defined so that a component being assessed will receive a score of 3 on an attribute if the component meets the market's expectation for that attribute, a score of 4 if the component exceeds expectations, and a score of 5 if the component greatly exceeds expectations or sets new precedent for how the attribute is reflected in the component. On the other hand, the descriptions are preferably defined so that a component that meets some expectations for an attribute (but fails to completely meet expectations) will receive a score of 2 for that attribute, and a component that obviously fails to meet expectations for the attribute (or is considered obsolete with reference to the attribute) will receive a score of 1.

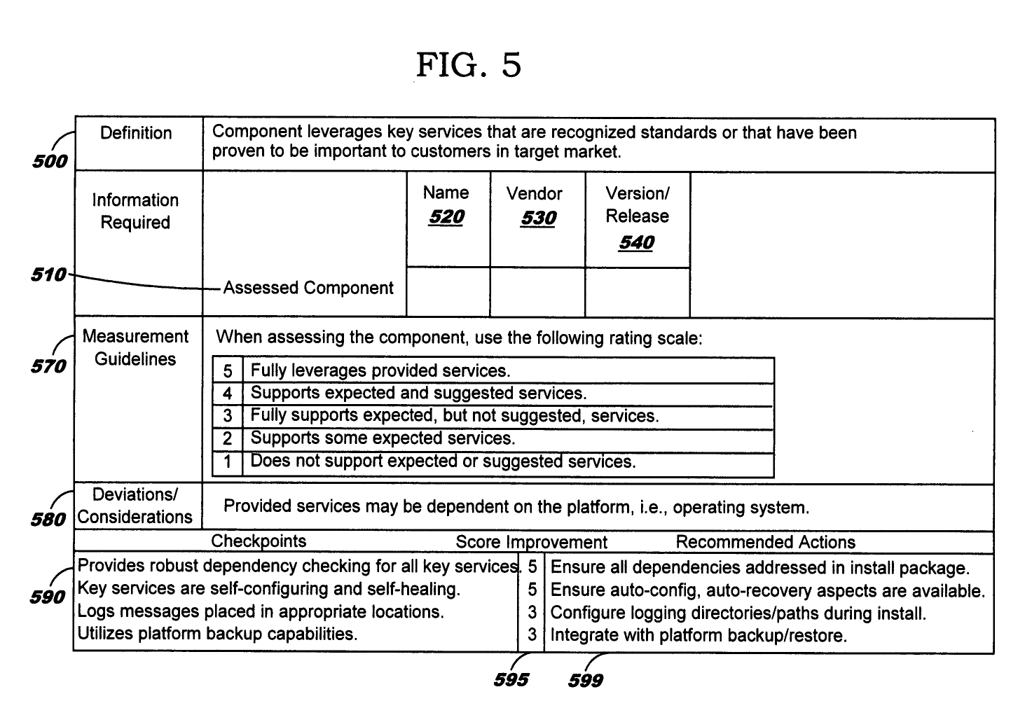

FIG. 5 provides an example of the textual descriptions that may be used to assign a value to the “exploits services of its target platform that have been proven to reduce total cost of ownership” attribute of the “Easy to Integrate” criterion that was stated above, and is representative of an entry from an evaluation form or workbook that may be used during the component assessment. As illustrated in FIG. 5, a definition 500 is preferably provided to explain the intent of this attribute to the component assessment team. (The information illustrated in FIG. 5 may be used during a component assessment carried out by a component assessment team, and/or by a component development team that wishes to determine how well its component will be assessed.)

A component name and vendor (see elements 520, 530) may be specified, along with version and release information (see element 540) or other information that identifies the particular component under assessment.

A set of measurement guidelines (see element 570) is preferably provided as textual descriptions for use by the component assessors. In the example, a value of 3 is assigned to this attribute if the component fully supports a set of “expected” services, but fails to support all “suggested” services. A value of 5 is assigned if the assessed component fully leverages all of the provided (i.e., expected as well as suggested) services, whereas a value of 1 is assigned if the component fails to support the expected services and the suggested services. If the assessed component supports (but does not fully leverage) expected and suggested services, then a value of 4 is assigned. And, if the assessed component supports some of the expected services, then a value of 2 is assigned. (What constitutes an “expected service” and a “suggested service” may vary widely from one component to another and/or from one target market to another.)

Element 580 indicates that an optional feature of preferred embodiments allows per-attribute deviations when assigning values to attributes for the assessed component. In this example, the deviation information explains that the provided services may be dependent on the platform(s) on which this component will be used.

One or more checkpoints and corresponding recommended actions may also be provided. See elements 590 and 599, respectively, where sample checkpoints and actions have been provided for this attribute. In addition, a set of values may be specified to indicate how providing each of these will impact or improve the component's assessment score. See element 595, where sample values have been provided. The information shown at 590-599 may be used, for example, when developing prescriptive statements of the type discussed earlier with reference to Block 115 of FIG. 1 in the component design application.

Information similar to that depicted in FIG. 5 is preferably created for measurement guidelines to be used by component assessors when assessing each of the remaining attributes.

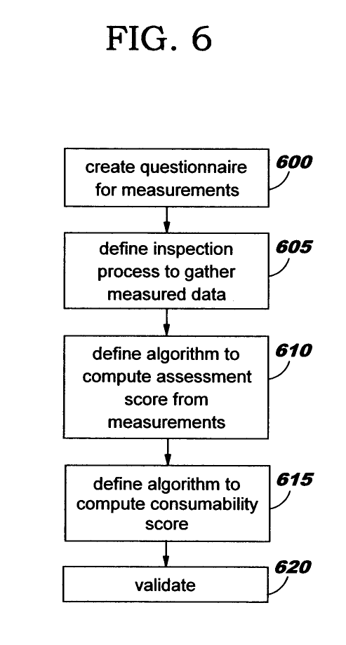

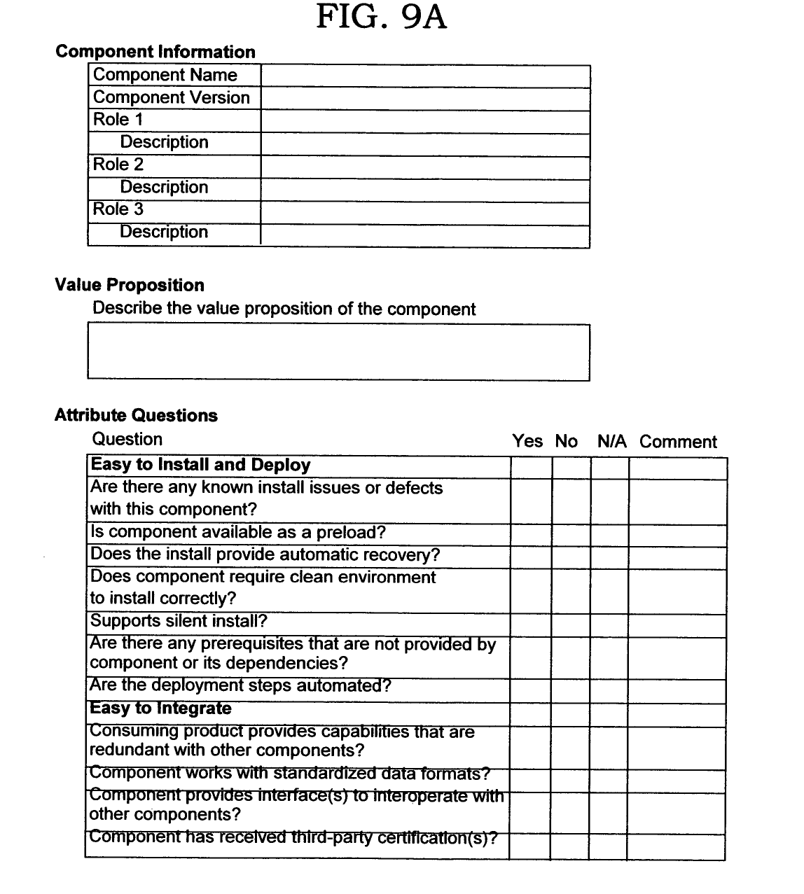

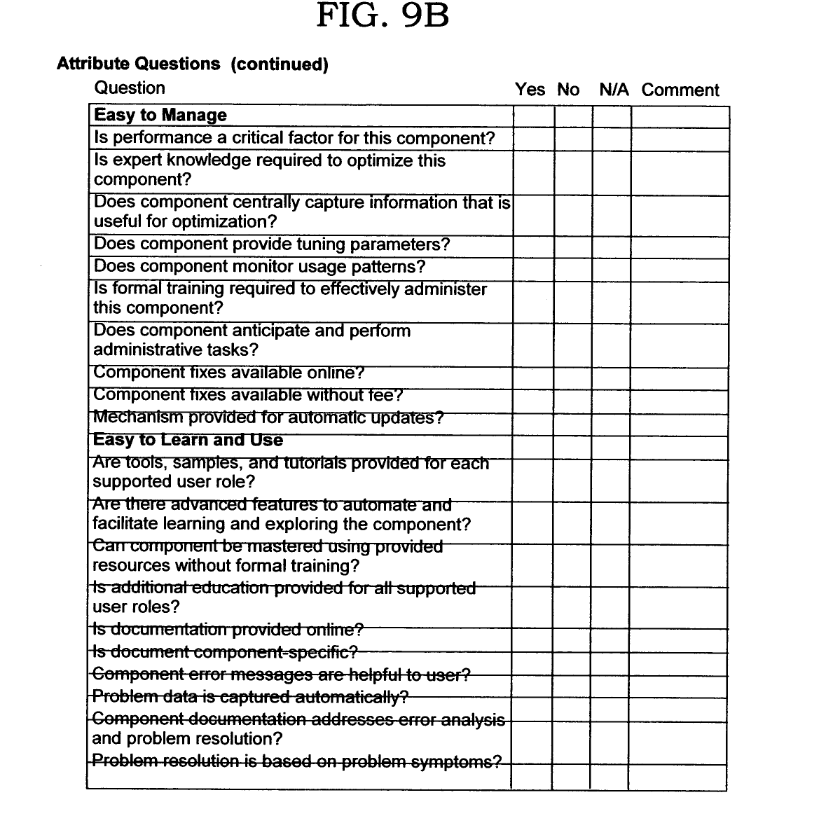

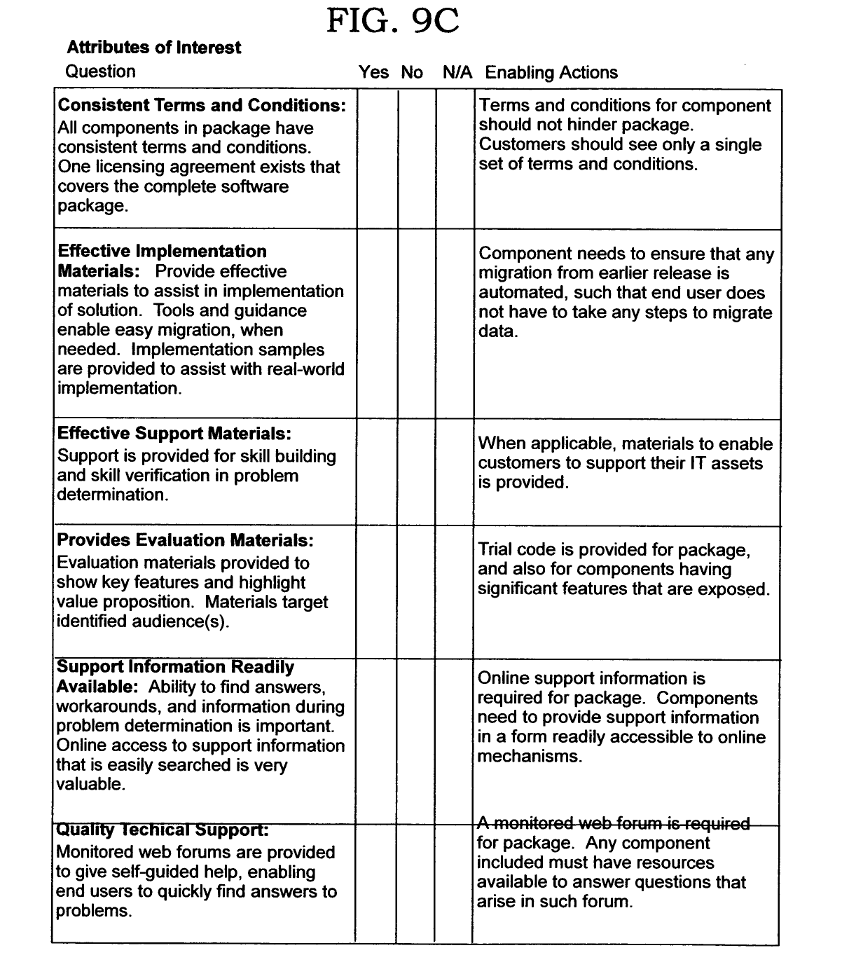

Referring now to FIG. 6, a flowchart is provided illustrating, at a high level, actions that are preferably carried out when establishing an assessment process according to the present invention. At Block 600, a questionnaire is preferably developed for use when gathering assessment data. Preferred embodiments of the present invention use an initial written or electronic questionnaire to solicit information from the component team. See FIG. 9 for an example of a questionnaire that may be used for this purpose. An inspection process is preferably defined (Block 605), where this inspection process is to be used for information-gathering as part of the assessment. This inspection is preferably an independent evaluation, performed by a component assessment team that is separate and distinct from the component development team, during which further details and measurement data will be gathered.

An algorithm or computational steps are preferably developed (Block 610) to use the measurement data for computing a component assessment score. An algorithm or computational steps are also preferably developed (Block 615) for computing a component's consumability score. Either or both of these algorithms may be embodied in a spread sheet or other automated technique.

One or more trial assessments may then be conducted (Block 620) for validation. For example, one or more existing components may be assessed, and the results thereof may be analyzed to determine whether an appropriate set of criteria, attributes, priorities, and deviations has been put in place. If necessary, adjustments may be made, and the process of FIG. 6 may be repeated in view of these adjustments. (Refer also to FIG. 1, which describes assessing components using an assessment process that may be established according to FIG. 6.)

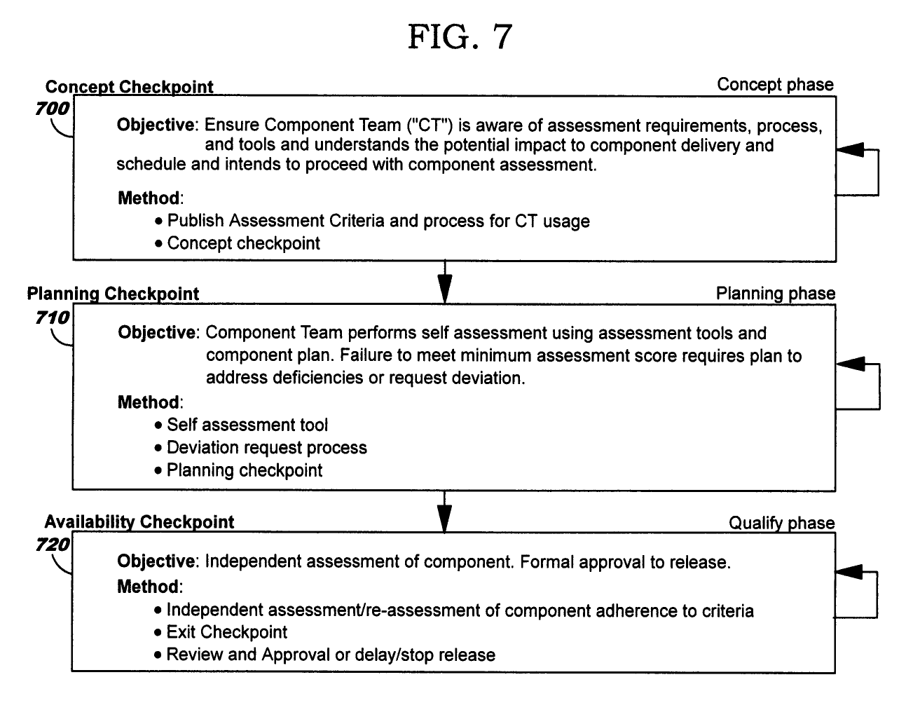

A component assessment as disclosed herein may be performed in an iterative manner. This is illustrated in FIG. 7. Accordingly, assessments or assessment-related activities may be carried out at various checkpoints (referred to equivalently herein as “plan checkpoints”) during a component's development. First, as shown at element 700, assessment activities may be carried out while a component is still in the concept phase (i.e., at a concept checkpoint). In preferred embodiments, this comprises ensuring that the component team (“CT”) is aware of the criteria and attributes that will be used to assess the component, as well as informing them about the manner in which the assessment will be performed and its impact on their delivery and scheduling requirements. This provides a prescriptive approach to component development, whereby the component developers may be provided with a list or set of market-specific goals such as “component will score a ‘5’ on ‘Easy to Learn and Use’ criterion if: (1) samples are provided for all exposed end-user functions; (2) all key functions can be learned by novice user within 2 attempts; . . . ”.

When the component reaches the planning checkpoint, plan information is preferably used to conduct an initial assessment. This initial assessment is preferably conducted by the component development team, as a self-assessment, using the same criteria and attributes (and the same textual descriptions of how values will be assigned) as will be used by the component assessment team later on. See element 710. The component development team preferably uses its component development plans (e.g., the planned component features) as a basis for this self-assessment. Performing an assessment while an IT component is still in the planning phase may prove valuable for guiding a component development plan. Component features can be selected from among a set of candidates, and the subsequent development effort can then focus its efforts, in view of how this component (plan) assessment indicates that the wants and needs of the target market will be met.

As stated earlier, a component assessment score is preferably expressed as a numeric value. A minimum value for an acceptable score is preferably defined, and if the self-assessment at the planning checkpoint is lower than this minimum value, then in preferred embodiments, the component development team is required to revise its component development plan to raise the component's score and/or to request a deviation for one or more low-scoring attributes. Optionally, approval of the revised plan or a deviation request may be required.

Another assessment is then preferably performed during the development phase, as the component nears the end of the development phase (e.g., prior to releasing the component for consumption by products). This is illustrated in FIG. 7 by the availability checkpoint (see element 720), and a suitable score during this assessment may be required as an exit checkpoint before the component qualifies for release to (i.e., inclusion in) a component library. Preferably, this assessment is carried out by an independent team of component assessors, as discussed earlier. At this phase, the assessment is performed using the developed component and its associated information (e.g., documentation, related tools, and so forth). According to preferred embodiments, if deficiencies are found in the assessed component, then recommendations are provided and the component is revised. Therefore, it may be necessary to repeat the independent assessment more than once.

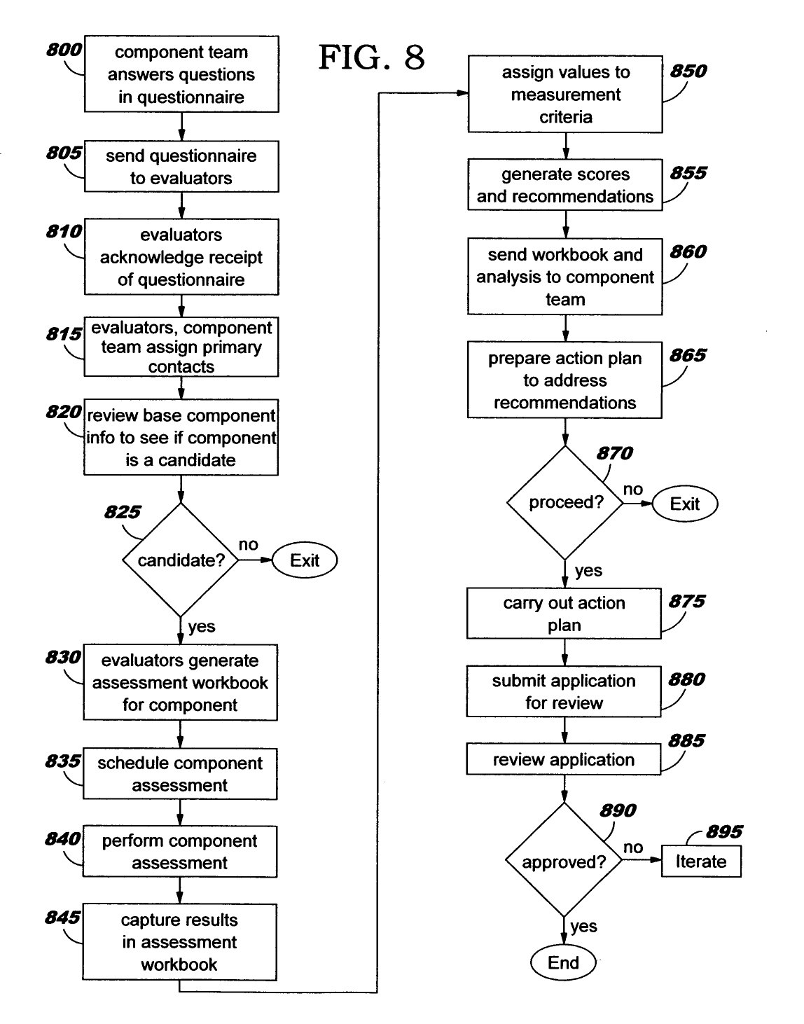

FIG. 8 provides a flowchart depicting, in more detail, how a component assessment may be carried out. The component team (e.g., planning team or development team, as appropriate) answers the questions on the assessment questionnaire that has been created (Block 800), and then submits this questionnaire (Block 805) to the assessors or evaluators. (FIG. 9 provides a sample questionnaire.) Optionally, the evaluators may acknowledge (Block 810) receipt of the questionnaire, and primary contact information may be exchanged (Block 815) between the component team and the evaluators.

The evaluators may optionally perform a review of basic component information (Block 820) to determine whether this component is a candidate for undergoing the assessment process. Depending on the outcome (Block 825), then the flow shown in FIG. 8 may exit (if the component is determined not to be a candidate) or it may continue at Block 830.

When Block 830 is reached, then this component is a candidate, and the evaluators preferably generate what is referred to herein as an “assessment workbook” for the component. The assessment workbook provides a centralized place for recording information about the component, and when assessments are performed during multiple phases (as discussed above), preferably includes the assessment information from each of the multiple assessments for the component. Items that may be recorded in the assessment workbook include planning information, competitive positioning of consuming products, comparative data for predecessor versions of a component, inspection findings, and/or assessment calculations. The assessment workbook may also record assessment scores for a baseline or product context, which may be used when computing a component's consumability score.

At Block 830, the assessment workbook is preferably populated (i.e., updated) with initial information taken from the questionnaire that was submitted by the component team at Block 800. Note that some of the information on the questionnaire may directly generate measurement data, while for other information, further details are required from the actual component assessment. For example, the target platform service exploitation information discussed above with reference to FIG. 5 (including measurement guidelines 570) could be included on a component questionnaire, and answers from the questionnaire could then be used to assign a value from 1 to 5. For measurements related to installation or execution, such as how long it takes a novice user to learn a component's key functions, the questionnaire answers are not sufficient, and thus values for these measurements will be supplied later (e.g., during the inspection).

A component assessment is preferably scheduled (Block 835), and is subsequently carried out (Block 840). Performing the assessment preferably comprises conducting an inspection of the component, when carried out during the development phase, or of the component development plan, when carried out in the planning phase. When the operational component (or an interim version thereof) is available, this inspection preferably includes simulating a “first-use” experience, whereby an independent team or party (i.e., someone other than a development team member) receives the component in a manner similar to its intended delivery (for example, when a component is proposed for inclusion in a developer's toolkit, as some number of CD-ROMs, other storage media, or download instructions, and so forth) and then begins to use the functions of the component. (Note that when an assessment is performed using an interim version of a component, the scores that are assigned for the various attributes preferably consider any differences that will exist between the interim version and the final version, to the extent that such differences are known. Preferably, the component planning/development team provides detailed information on such differences to the component assessment team. If no operational code is available, then the inspection may be performed by review of code or similar documentation.)

Results of the inspection are captured (Block 845) in the assessment workbook. Values are assigned for each of the measurement attributes (Block 850), and these values are recorded in the assessment workbook. As discussed earlier, these values are preferably selected from a numeric range, such as 1 to 5, and textual descriptions are preferably defined in advance to assist the assessors in consistently applying the measurements to achieve an objective component assessment score.

Once the inspection has been completed and values are assigned and recorded for all of the measurement attributes, a component assessment score and consumability score are generated (Block 855). The manner in which the scores are computed, given the gathered information, may vary widely. A preferred approach has been described above (see, for example, the discussion of FIGS. 1 and 2). One or more recommendations may also be generated, depending on how the component scores on particular attributes, to inform the component team where changes should be made to improve the component's score (and therefore, to improve the component's reusability and/or other factors such as what impact the component will have on acceptance of consuming products by their target market).

According to preferred embodiments, any measurement attribute for which the assigned value is 1 or 2 requires follow-up action by the component team, as these are not considered acceptable values. Thus, attributes receiving these values are preferably flagged or otherwise indicated in the assessment workbook. Preferred embodiments also require an overall assessment score of at least 7 on a scale of 0 to 10, and any component scoring lower than 7 requires review of its assessment attributes and improvement before being approved for release and/or inclusion in a component library. (Overall scores and minimum required scores may be expressed in other ways, such as by using percentages values, without deviating from the scope of the present invention.) Optionally, selected attributes may be designated as critical or imperative for acceptance of this component's functionality in the target marketplace. In this case, even though a component's overall assessment score exceeds the minimum acceptable value, if it scores a 1 or 2 on a critical attribute, then review and improvement is required on these scores before the component can be approved.

When weights have been assigned to the various measurement attributes, then these weights may be used to prioritize the recommendations that result from the assessment. In this manner, actions that will result in the biggest improvement in the component assessment score can be addressed first.

The assessment workbook and analysis is then sent to the component team (Block 860) for their review. The component team then prepares an action plan (Block 865), as necessary, to address each of the recommendations. A meeting between the component assessors and representatives of the component team may be held to discuss the findings in the assessment workbook and/or the recommendations. The action plan may be prepared thereafter. Preferably, the actions from this action plan are recorded in the assessment workbook.

At Block 870, a test is made as to whether this component (or component plan) should proceed. If not (for example, if the component assessment score is too low, and sufficient improvements do not appear likely or cost-effective), then the process of FIG. 8 is exited. Otherwise, as shown at Block 875, the action plan is carried out. For example, if the component is still in the planning phase, then Block 875 may comprise selecting different features to be included in the component and/or redefining the existing features. If the component is in the development phase, then Block 875 may comprise redesigning function, revising documentation, and so forth, depending on where low attribute scores were assigned.

Block 880 indicates that, when the component's action plan has been carried out, an application for component approval may be submitted. This application is then reviewed (Block 885) by the appropriate person(s), who is/are preferably distinct from the assessment team, and if approved (i.e., the test at Block 890 has a positive result), then the process of FIG. 8 is complete. Otherwise, if Block 890 has a negative result, then the component's application is not approved (for example, because the component's assessment score is still too low, or the low-scoring attributes are not sufficiently improved, or because this is an interim assessment), and the process of FIG. 8 iterates, as shown at Block 895.

Optionally, a special designation may be granted to the component when the test in Block 890 has a positive result. This designation may be used, for example, to indicate that this component has achieved at least some predetermined assessment score with regard to the assessment criteria, thereby enabling developers to consider this designation when selecting from among a set of candidate components provided in a component library or toolkit. A component that fails to meet this predetermined assessment score may still be released for reuse, but without the special designation. Furthermore, the test performed at Block 825 of FIG. 8 may be made with reference to whether the component's basic information indicates that this component is a candidate for receiving the special designation, and the decisions made at Block 870 and 890 may be made with reference to whether this component remains a candidate for, and should receive, respectively, the special designation.

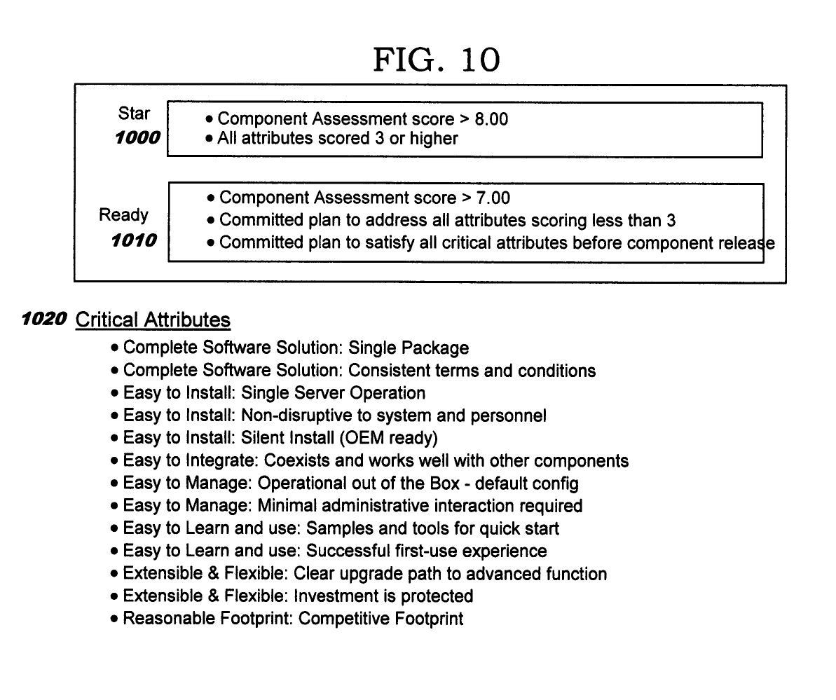

As stated earlier, a minimum acceptable assessment score is preferably specified for components to be assessed using the component assessment process. In addition to using this minimum score for determining when an assessed component is required either (i) to make changes and undergo a subsequent assessment and/or (ii) to justify its deviations, the minimum score may be used as a gating factor for receiving the special designation discussed above. Referring now to FIG. 10, an example is provided that illustrates how two different scores may be used for determining whether a component is ready for release and whether a component will receive a special designation. As shown therein (see element 1000), a component may be designated as “star” if its overall component assessment score exceeds 8.00 (or some other appropriate score) and each of the assessed attributes has been assigned a value of 3 or higher on the 5-point scale. Or, the component may be designated as “ready” (see element 1010) if the following criteria are met: (1) its overall component assessment score exceeds 7.00; (2) a committed plan has been developed that addresses all attributes scoring lower than 3 on the 5-point scale; and (3) a committed plan is in place to satisfy, before release of the component, all attributes that have been determined to be “critical”. In this example, the “ready” designation indicates that the component has scored high enough to be released, whereas the “star” designation indicates that the component has also scored high enough to receive this special designation. (Alternative criteria for assigning a special designation to a component may be defined, according to the needs of a particular environment in which the techniques disclosed herein are used.)

Element 1020 provides a sample list of criteria and attributes that have been identified as critical. In this example, 7 of the 8 measurement criteria from FIG. 3 are represented. (That is, a critical attribute has not been identified for the “target market platform support” category.) For these 7 criteria, 13 different attributes are identified as critical. By comparing the list at 1020 to the attributes identified in FIG. 3, it can be seen that there are a number of attributes that are considered important for measuring, but that are not considered to be critical. Preferably, the identification of critical attributes is substantiated with market intelligence or consumer feedback. This list may be revised over time, as necessary, to keep pace with changes in that information. When weights are assigned to attributes for computing a component's assessment score, as discussed above, a relatively higher weight is preferably assigned to the attributes appearing on the critical attributes list.

FIG. 11 shows a sample component assessment report 1100 where attributes of a hypothetical “Widget” component have been assessed and scored. Preferably, a report is prepared after each assessment, and provides information that has been captured in the assessment workbook. A “measurement criteria” column 1110 lists criteria which were measured, and in this example, the criteria are provided in a summarized form. (As an alternative, a report may be provided that gives details of each individual attribute measured for each of the criteria.)

For each assessed criteria, the assessment report indicates how the component scored on that criteria (see the “Score” column 1120); the weight assigned to prioritize that criterion (see the “Wt.” column 1130); the change, or “delta”, for this criterion in the assessed component as compared to a baseline or product score for that same criterion (see the “Delta” column 1140); and the contribution that this weighted change would make to the overall assessment score for a consuming product (see the “Contr.” column 1150, which has been computed by multiplying the values in columns 1130 and 1140). As discussed earlier with regard to FIG. 1, a consumability score 1160 is preferably computed by summing the weighted values in column 1150. In this example, several of the assessed criteria for the Widget Component are identified as hindering to consuming products (see rows 1172, 1175), while others are identified as helping (see rows 1171, 1173, 1774) and yet others are expected to have no impact on a consuming product's assessment score (and are thus shown with a “0.00” contribution in column 1150). The consumability score 1160 for this sample report is shown as a net improvement of 2.50. (In an alternative approach, this value might be scaled in view of the number of assessed criteria.)

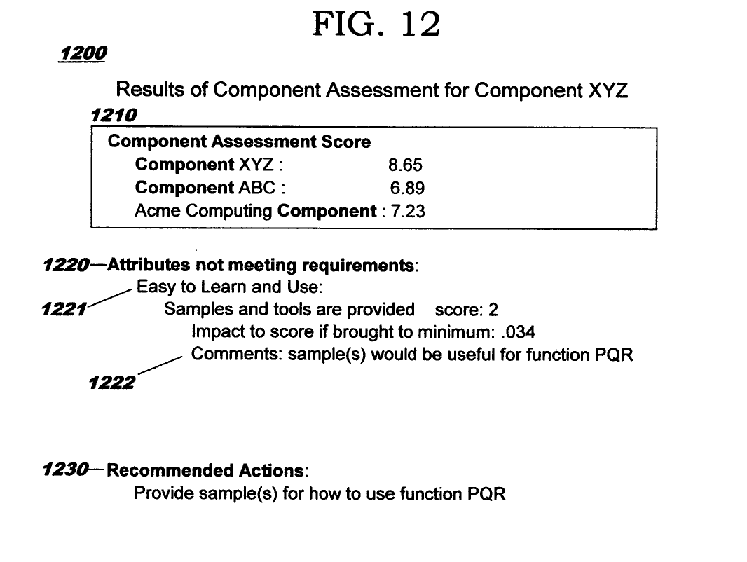

FIG. 12 shows a sample summary report 1200 providing an example of summarized assessment results for an assessed component named “Component XYZ”. As shown at element 1210, the component's overall assessment score is listed. In this example, the assessed component has received an overall score of 8.65. Furthermore, the assessment summary report for this component provides assessment scores for two other components, “Component ABC” and “Acme Computing Component”, which presumably offer the same (or similar) functional capabilities as “Component XYZ”. Using the same measurement criteria and attributes, these products received scores of 6.89 and 7.23, respectively. Thus, the component team may be provided with an at-a-glance view of how their component compares to other components providing the same functional capabilities. This allows the component team to determine how well their component will be received, and when the score is lower than the required minimum, to gauge the amount of rework that will be necessary before the component should be released for consumption.

Optionally, this summary report 1200 may be augmented to include consumability scores for each of the other components (i.e., for Component ABC and Acme Computing Component, in the example), although this has not been shown in FIG. 12.

A summary 1220 is also provided, listing each of the attributes that did not achieve the minimum acceptable score (which, in preferred embodiments, is a 3 on the 5-point scale, as stated above). In this example, one attribute of the “Easy to Learn and Use” criterion (see 1221) failed to meet this minimum score. In the example report, the actual score assigned to the failing attribute is presented, along with an impact value and comments. The impact value indicates, for each failing attribute, how much of an improvement to the overall assessment score would be realized if this attribute's score was raised to the minimum score of 3. For each attribute in this summary 1220, the assessment team preferably provides comments that explain why the particular attribute value was assigned. Thus, as shown in this example (see 1222), an improvement of 0.034 could be realized in the component's assessment score (from a score of “2”) if samples were provided for some function “PQR”.

A recommended actions summary 1230 is also provided, according to preferred embodiments, notifying the component team as to the assessment team's recommendations for improving the component's score. In this example, a recommended action has been provided for the attribute 1221 that did not meet requirements.

Preferably, the attributes in summary 1220 and the corresponding actions in summary 1230 are listed in decreasing order of potential improvement in the assessment score. This prioritized ranking is beneficial to the component development team, as it allows them to prioritize their efforts for revising the component in view of where the most significant gains can be made in the component's assessment score. (Preferably, attribute weights are used in determining the impact values shown for each attribute in summary 1220, and these impact values are then used for the prioritization.)

Additionally, more-detailed information may also be included in assessment reports, although this detail has not been shown in the sample report 1200. Preferably, the summary information shown in FIG. 12 is accompanied by a complete listing of all attributes that were measured, the measurement values assigned to those attributes, and any comments provided by the assessment team (which may be in a form such as sample report 1100 of FIG. 11). If this component has previously undergone an assessment and is being reassessed as to improvements that have been made, then the earlier measurement values are also preferably provided. Optionally, where critical attributes have been defined, these attributes may be visually highlighted in the report.

As has been demonstrated, the present invention defines advantageous techniques for selecting from among a plurality of IT components, using per-component consumability scores that result from component assessments, and for determining how well the associated component will enable (or hinder) consuming products in achieving specific requirements of the target market.

As will be appreciated by one of skill in the art, embodiments of the present invention may be provided as methods, systems, or computer program products comprising computer-readable program code. Accordingly, the present invention may take the form of an entirely hardware embodiment, an entirely software embodiment, or an embodiment combining software and hardware aspects. The computer program products maybe embodied on one or more computer-usable storage media (including, but not limited to, disk storage, CD-ROM, optical storage, and so forth) having computer-readable program code embodied therein.

When implemented by computer-readable program code, the instructions contained therein may be provided to a processor of a general purpose computer, special purpose computer, embedded processor, or other programmable data processing apparatus to produce a machine, such that the instructions, which execute via the processor of the computer or other programmable data processing apparatus, create means for implementing embodiments of the present invention.

These computer-readable program code instructions may also be stored in a computer-readable memory that can direct a computer or other programmable data processing apparatus to function in a particular manner, such that the instructions stored in the computer-readable memory produce an article of manufacture including instruction means which implement embodiments of the present invention.

The computer-readable program code instructions may also be loaded onto a computer or other programmable data processing apparatus to cause a series of operational steps to be performed on the computer or other programmable apparatus to produce a computer-implemented method such that the instructions which execute on the computer or other programmable apparatus provide steps for implementing embodiments of the present invention.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention.

1. A method of selecting information technology (“IT”) components, comprising steps of:
determining a plurality of criteria that are important to a target market, and at least one attribute to be used for measuring each of the criteria;
specifying objective measurements for each of the attributes;
conducting an evaluation of an IT component, further comprising steps of:
inspecting a representation of the IT component, with reference to selected ones of the attributes; and
assigning attribute scores for the selected attributes, according to how the IT component compares to the specified objective measurements; and
generating a consumability score, for the IT component, further comprising steps of:
comparing the assigned attribute scores to product or baseline scores for each attribute;
multiplying a result of each comparison by a weight associated with the attribute to yield a differential attribute score; and
summing the differential attribute scores.

2. The method according to claim 1, further comprising the step of generating a list of recommended actions for improving attributes of the component, responsive to ones of the assigned attribute scores that fall below a predetermined threshold score.

3. The method according to claim 1, wherein the weights associated with each of the attributes is assigned in view of the attribute's importance to the target market.

4. The method according to claim 1, wherein the consumability score is programmatically generated.

5. The method according to claim 1, wherein the step of conducting an evaluation is repeated at a plurality of plan checkpoints used in developing the IT component.

6. The method according to claim 5, wherein successful completion of each of the plan checkpoints requires the assigned attribute scores to exceed a predetermined threshold.

7. The method according to claim 1, wherein a component team developing the IT component provides input for the evaluation by answering questions on a questionnaire that reflects the attributes.

8. The method according to claim 1, wherein the assigned attribute scores and the consumability scores are recorded in a workbook.

9. The method according to claim 8, wherein the workbook is an electronic workbook.

10. The method according to claim 1, wherein a component team developing the IT component provides input for the evaluation by answering questions on a questionnaire that reflects the attributes, and wherein the answers to the questions, the assigned attribute scores, and the consumability score are recorded in an electronic workbook.

11. The method according to claim 1, further comprising the step of assigning a special designation to the IT component if and only if the consumability score exceeds a predefined threshold.

12. The method according to claim 1, wherein the specified objective measurements further comprise textual descriptions to be used in the step of assigning attribute scores.

13. The method according to claim 12, wherein the textual descriptions identify guidelines for assigning the attribute scores using a multi-point scale.

14. The method according to claim 1, further comprising the step of using the generated consumability score to determine whether the IT component may exit a plan checkpoint.

15. The method according to claim 1, further comprising the step of using the generated consumability score to determine whether the IT component is included in a component library.

16. The method according to claim 1, further comprising the step of using the generated consumability score to determine whether the IT component is consumable by a software product or offering.

17. The method according to claim 1, further comprising the step of using the generated consumability score to rank the IT component with reference to at least one other IT component, each of the at least one IT components also having consumability scores.

18. The method according to claim 1, further comprising the step of using the generated consumability score to gauge whether the IT component will help or hinder consuming software products or offerings.

19. The method according to claim 1, further comprising the step of using the generated consumability score to gauge potential improvement to product assessment scores for a consuming software product that desires to incorporate the IT component.

20. The method according to claim 1, wherein the representation comprises an identification of functional capability that is proposed for harvesting from existing code as a reusable component.

21. The method according to claim 1, further comprising the step of releasing the IT component for use in a component toolkit if the generated consumability score meets or exceeds a predetermined threshold.

22. A system for selecting information technology (“IT”) components, comprising:
a plurality of criteria that are determined to be important to the target market, and at least one attribute that may be used for measuring each of the criteria, wherein the attributes are weighted in view of their importance to the target market;
objective measurements that are specified for each of the attributes;
means for conducting an evaluation of the IT component, further comprising:
means for inspecting a representation of the IT component, with reference to selected ones of the attributes; and
means for assigning attribute scores for the selected attributes, according to how the IT component compares to the specified objective measurements; and
means for generating a consumability score, for the IT component, further comprising:
means for comparing the assigned attribute scores to product or baseline scores for each attribute;
means for multiplying a result of each comparison by a weight associated with the attribute to yield a differential attribute score; and
means for summing the differential attribute scores.

23. A computer program product for assessing information technology (“IT”) components for their target market, the computer program product embodied on one or more computer-readable media and comprising computer-readable instructions that, when executed on a computer, cause the computer to carry out steps of:
determining a plurality of criteria that are important to a target market, and at least one attribute to be used for measuring each of the criteria;
specifying objective measurements for each of the attributes;
conducting an evaluation of an IT component, further comprising steps of:
inspecting a representation of the IT component, with reference to selected ones of the attributes; and
assigning attribute scores for the selected attributes, according to how the IT component compares to the specified objective measurements; and
generating a consumability score, for the IT component, further comprising steps of:
comparing the assigned attribute scores to product or baseline scores for each attribute;
multiplying a result of each comparison by a weight associated with the attribute to yield a differential attribute score; and
summing the differential attribute scores.
